(19) United States
(12) Patent Application Publication
(10) Pub. No.: US 2025/0233287 A1
(43) Pub. Date: Jul. 17, 2025

(54) BATTERY CELL TAB SHAPE VARIATIONS FOR OPTIMIZING BATTERY CELL-TO-BUSBAR ELECTRICAL CONNECTIONS

(71) Applicant: FORD GLOBAL TECHNOLOGIES, LLC, Dearborn, MI (US)

(72) Inventors: Paul John Bojanowski, Macomb Township, MI (US); Jeremy Rauch, Grass Lake, MI (US); Brian Utley, Canton, MI (US)

(21) Appl. No.: 18/410,012

(22) Filed: Jan. 11, 2024

(51) Int. Cl. H01M 50/553; H01M 50/178; H01M 50/503; H01M 50/516; H01M 50/522; H01M 50/562

(52) U.S. Cl. CPC H01M 50/553; H01M 50/178; H01M 50/503; H01M 50/516; H01M 50/522; H01M 50/562; H01M 2220/20

(57) ABSTRACT

Exemplary battery cell tab terminal and busbar configurations are provided for electrically connecting battery cells within a traction battery pack. An exemplary battery cell may include a tab terminal having a tab end section shaped to provide a local thickness increase that is adapted for reducing weld spatter and increasing weld quality when welding the tab terminal to a busbar. The busbar may include a weld joint backing structure that facilitates positioning and welding the tab terminal to the busbar.

### TECHNICAL FIELD

This disclosure relates generally to electrified vehicle traction battery packs, and more particularly to techniques for electrically connecting battery cells of traction battery packs.

### BACKGROUND

A high voltage traction battery pack typically powers the electric machines and other electrical loads of an electrified vehicle. The traction battery pack includes a plurality of battery cells. The battery cells must be reliably connected to one another in order to provide the voltage and power levels necessary for achieving vehicle propulsion.

### SUMMARY

A battery cell according to an exemplary aspect of the present disclosure includes, among other things, a housing and a tab terminal that protrudes outwardly from the housing. The tab terminal includes a tab end section having a shape that provides a local thickness increase adapted for reducing weld spatter when welding the tab terminal to a busbar.

In a further non-limiting embodiment of the foregoing battery cell, the shape includes a crimped portion that provides the local thickness increase at the tab end section.

In a further non-limiting embodiment of either of the foregoing battery cells, the shape extends along a curved path that provides the local thickness increase at the tab end section.

In a further non-limiting embodiment of any of the foregoing battery cells, the curved path establishes a convex shape of the tab end section.

In a further non-limiting embodiment of any of the foregoing battery cells, a first bend connects the tab end section to a tab proximal section of the tab terminal.

In a further non-limiting embodiment of any of the foregoing battery cells, a second bend connects a distal tip portion of the tab end section to a proximal tip portion of the tab end section.

In a further non-limiting embodiment of any of the foregoing battery cells, the distal tip portion is folded toward the proximal tip portion about the second bend.

In a further non-limiting embodiment of any of the foregoing battery cells, the second bend establishes a portion of a crimped portion of the tab end section.

In a further non-limiting embodiment of any of the foregoing battery cells, a second bend positions a distal tip portion of the tab end section at an angle relative to a proximal tip portion of the tab end section.

In a further non-limiting embodiment of any of the foregoing battery cells, the distal tip portion extends toward the tab proximal section and is spaced therefrom.

A traction battery pack according to another exemplary aspect of the present disclosure includes, among other things, a busbar including an opening and a weld joint backing structure provided near the opening, a battery cell including a tab terminal that extends into the opening to a position adjacent to the weld joint backing structure, and a weld that secures the tab terminal to the weld joint backing structure.

In a further non-limiting embodiment of the foregoing traction battery pack, the weld joint backing structure includes a bent portion.

In a further non-limiting embodiment of either of the foregoing traction battery packs, a distal end section of the tab terminal is received against an angled surface of the bent portion of the weld joint backing structure.

In a further non-limiting embodiment of any of the foregoing traction battery packs, the distal end section includes a crimped portion or extends along a curved path to establish a local thickness increase.

In a further non-limiting embodiment of any of the foregoing traction battery packs, the weld joint backing structure includes a bent portion that is bent relative to a body of the busbar.

In a further non-limiting embodiment of any of the foregoing traction battery packs, a distal end section of the tab terminal is received against an angled surface of the bent portion of the weld joint backing structure.

In a further non-limiting embodiment of any of the foregoing traction battery packs, the distal end section includes a crimped portion or extends along a curved path to establish a local thickness increase.

In a further non-limiting embodiment of any of the foregoing traction battery packs, the tab terminal includes at least two bends.

In a further non-limiting embodiment of any of the foregoing traction battery packs, the busbar includes a first metallic material, and the tab terminal includes a second metallic material that is different from the first metallic material.

A method for establishing an electrical connection between a battery cell and a busbar according to another exemplary aspect of the present disclosure includes, among other things, positioning a tab terminal of the battery cell into an opening of the busbar and to a position that is adjacent to a weld joint backing structure of the busbar, and welding the tab terminal to the weld joint backing structure. The tab terminal includes a shape that provides a local thickness increase within a tab end section of the tab terminal for reducing weld spatter and increasing weld quality during the welding.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is a perspective view of a traction battery pack of an electrified vehicle.

FIG. 3 is a highly schematic cross-sectional view of the traction battery pack of FIG. 2.

FIG. 4 illustrates a battery cell for use within a traction battery pack.

FIG. 5 illustrates select portions of a busbar configured for joining tab terminals of a grouping of battery cells.

FIG. 6 is a cross-sectional view through section 6-6 of FIG. 5.

FIG. 7 is a cross-sectional view of another exemplary busbar for joining tab terminals of a grouping of battery cells.

FIGS. 8A and 8B illustrate an exemplary tab terminal of a battery cell.

FIGS. 9A and 9B illustrate another exemplary tab terminal of a battery cell.

FIG. 10 illustrates another exemplary tab terminal of a battery cell.

FIG. 11 illustrates another exemplary tab terminal of a battery cell.

FIG. 12 illustrates another exemplary tab terminal of a battery cell.

FIG. 13 illustrates yet another exemplary tab terminal of a battery cell.

### DETAILED DESCRIPTION

This disclosure details exemplary battery cell tab terminal and busbar configurations for electrically connecting battery cells within a traction battery pack. An exemplary battery cell may include a tab terminal having a tab end section shaped to provide a local thickness increase that is adapted for reducing weld spatter and increasing weld quality when welding the tab terminal to a busbar. The busbar may include a weld joint backing structure that facilitates positioning and welding the tab terminal to the busbar. These and other features are discussed in greater detail in the following paragraphs of this detailed description.

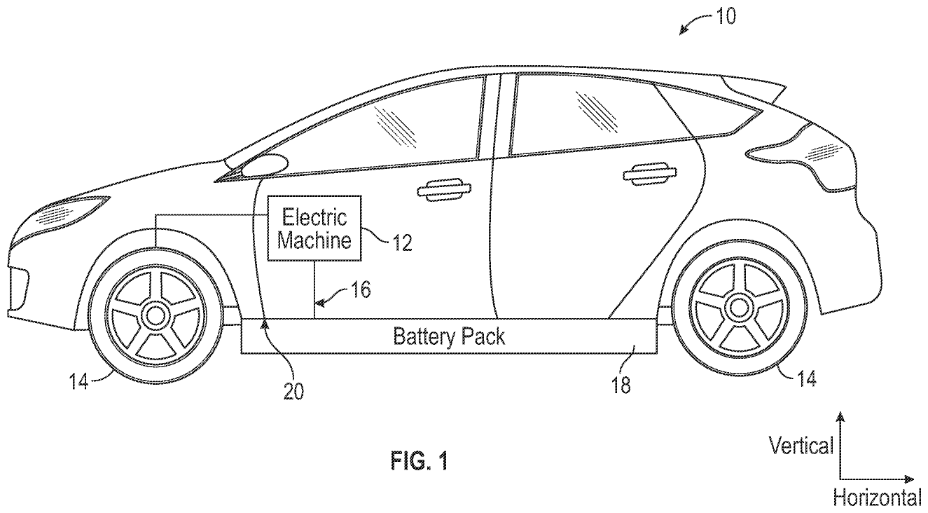

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

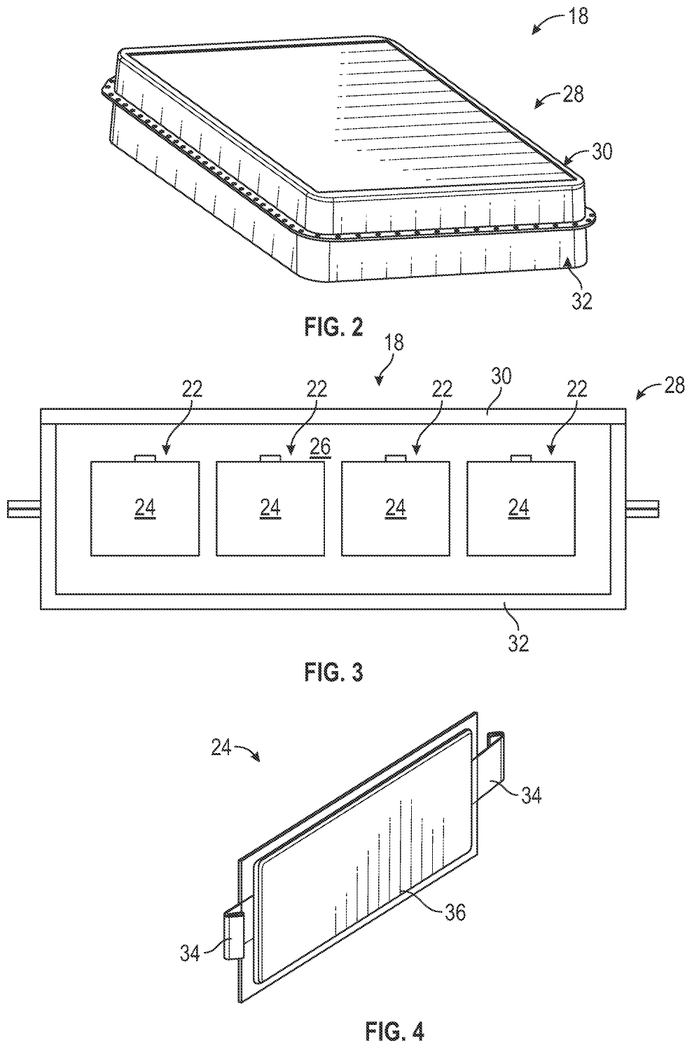

FIGS. 2 and 3 illustrate additional details associated with the traction battery pack 18 of the electrified vehicle 10. The traction battery pack 18 may include one or more battery arrays 22 (e.g., battery assemblies or groupings of rechargeable battery cells 24) capable of outputting electrical power to power the electric machine 12 and/or other electrical loads of the electrified vehicle 10. Other types of energy storage devices and/or output devices could alternatively or additionally be used to electrically power the electrified vehicle 10.

The battery cells 24 may be stacked side-by-side along a stack axis to construct a grouping of battery cells 24, sometimes referred to as a “cell stack.” In the highly schematic depiction of FIG. 3, the battery cells 24 are stacked in a direction into the page to construct each battery array 22, and thus the battery arrays 22 may extend in cross-car direction. However, other configurations may also be possible. The total numbers of battery arrays 22 and battery cells 24 provided within the traction battery pack 18 are not intended to limit this disclosure.

In an embodiment, the battery cells 24 of each battery array 22 are pouch style, lithium-ion cells. However, battery cells having other geometries (cylindrical, prismatic, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 (see FIG. 3) of an enclosure assembly 28.

The enclosure assembly 28 may include an enclosure cover 30 and an enclosure tray 32. The enclosure cover 30 may be secured (e.g., bolted, welded, adhered, etc.) to the enclosure tray 32 to provide the interior area 26. The size, shape, and overall configuration of the enclosure assembly 28 is not intended to limit this disclosure.

FIG. 4 illustrates one of the battery cells 24 that can be provided within the traction battery pack 18. Each battery cell 24 may include a housing 36 and a pair of tab terminals 34 that project outwardly from the housing 36. In an embodiment, each battery cell 24 includes two tab terminals 34, with one tab terminal 34 protruding outwardly at each opposing side of the housing 36. One of the tab terminals 34 may be provide the positive terminal of the battery cell 24, and the other tab terminal 34 may provide the negative terminal of the battery cell 24. However, other configurations are further contemplated within the scope of this disclosure.

The tab terminals 34 of the battery cells 24 of each battery array 22 must be reliably connected to one another in order to provide the voltage and power levels necessary for achieving vehicle propulsion. Busbars are sometimes used for making these connections, however, it can be difficult to properly position and align the tab terminals 34 relative to the busbar during assembly and welding processes. Moreover, the busbars are typically thicker than the tab terminals 34, thereby introducing welding complexities that can result in weld-through and/or weld spatter. This disclosure is therefore specifically directed to tab terminal shape variations that can be used for optimizing battery cell-to-busbar electrical connections.

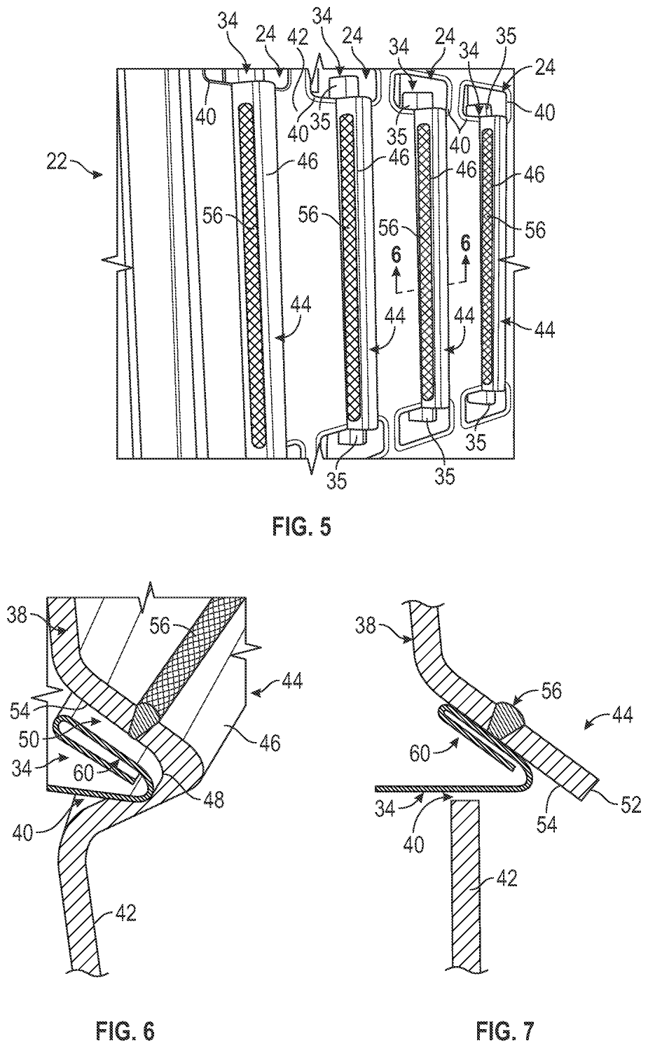

FIGS. 5 and 6 illustrate select portions of a busbar 38 that can be joined to the tab terminals 34 of a grouping of battery cells 24 for electrically connecting the battery cells 24. The grouping of battery cells 24 may be part of one of the battery arrays 22 of the traction battery pack 18, for example. Once electrically coupled, the battery cells 24 may supply electrical power for powering various components of the electrified vehicle 10.

The tab terminals 34 and the busbar 38 may be metallic components. In an embodiment, the busbar 38 is made of copper or aluminum, and the tab terminals are made of aluminum. However, other materials or combinations of materials are contemplated within the scope of this disclosure.

The busbar 38 may include a plurality of openings 40. Each opening 40 may be formed through a body 42 of the busbar 38 and may be sized for receiving one of the tab terminals 34. Each tab terminal 34 may extend at least partially into one of the openings 40.

The busbar 38 may additionally include a plurality of weld joint backing structures 44 at which the tab terminals 34 may interface with the busbar 38. One weld joint backing structure 44 may be provided at each opening 40 of the busbar 38 and could be configured to establish a base of the opening 40, for example. In an embodiment, the weld joint backing structures 44 extend from the body 42 in a direction away from the battery cells 24.

In an embodiment, each weld joint backing structure 44 may include a bent portion 46 that is formed in the body 42 of the busbar 38. The bent portion 46 may extend in a direction away from the battery cell 24 from which the tab terminal 34 protrudes and may provide an elongated groove 50 for receiving the tab terminal 34. The bent portion 46 may limit the distance the tab terminal 34 can be inserted into the elongated groove 50. For example, an inner surface 48 of the bent portion 46 may act as a stop for limiting the insertion distance of the tab terminal 34. In this way, the bent portions 46 can help locate and position the tab terminals 34 relative to the busbar 38. Outboard sections 35 (see FIG. 5) of the tab terminals 34 may extend outside of the elongated grooves 50 established by the bent portions 46.

In another embodiment, each weld joint backing structure 44 may include a flared portion 52 as an alternative to the bent portion 46 (see FIG. 7). Each flared portion 52 may protrude in a direction away from the battery cells 24.

The tab terminals 34 may be received against an angled surface 54 of the weld joint backing structures 44. Each angled surface 54 may provide a relatively flat surface for creating one or more welds 56 for joining tab end section 60 with the angle surface 54.

Each tab terminal 34 may be joined to the angled surface 54 of one of the weld joint backing structures 44 of the busbar 38 by one or more welds 56. The welds 56 may be linear welds, non-linear welds, or any other weld patterns. Prior to formation of the welds 56, the tab terminals 34 could optionally be clamped and/or tack welded to the weld joint backing structures 44 to aid in the joining process.

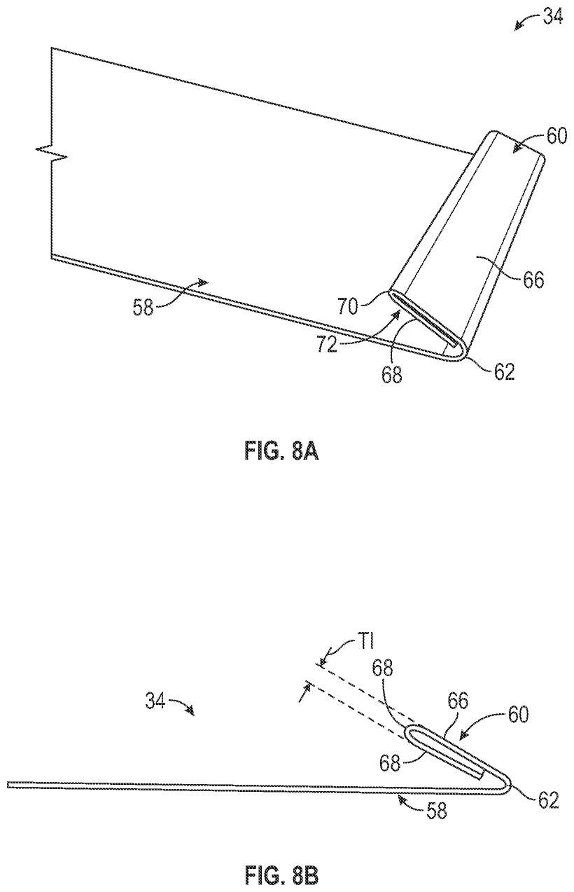

The shape of each tab terminal 34 may be specifically designed to optimize the battery cell-to-busbar electrical connection. A first exemplary tab terminal 34 configuration that can provide optimized battery cell-to-busbar electrical connections is shown in FIGS. 8A and 8B (with continued reference to FIGS. 3-6). The exemplary tab terminal 34 may include a tab proximal section 58 that extends from cell internal electrodes to a position outside of the housing 36 of the battery cell 24. The tab proximal section 58 may be substantially straight along its length.

The tab terminal 34 may additionally include a first bend 62 that positions a tab end section 60 at an angle relative to the tab proximal section 58. The tab end section 60 may include a proximal tip portion 66 and a distal tip portion 68. The distal tip portion 68 may be folded toward the proximal tip portion 66 about a second bend 70. Once folded, the distal tip portion 68 may be positioned between the proximal tip portion 66 and the tab proximal section 58. The distal tip portion 68 may contact the tab proximal section 58 or could be slightly spaced therefrom.

Together, the proximal tip portion 66, the distal tip portion 68, and the second bend 70 may establish a crimped portion 72 of the tab end section 60. The crimped portion 72 provides a local thickness increase TI at the tab end section 60 of the tab terminal 34. The tab terminal 34 is thus less prone to weld through and effectively limits weld spatter in a direction toward the battery cell 24 during the process of welding the tab end section 60 of the tab terminal 34 to the busbar 38.

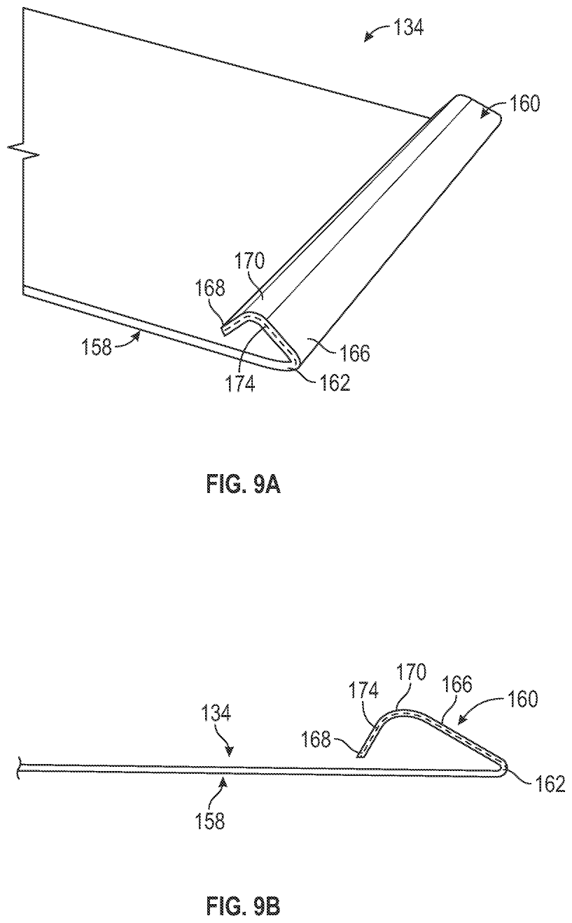

FIGS. 9A and 9B illustrate another exemplary tab terminal 134 that is shaped to optimize a battery cell-to-busbar electrical connection. The exemplary tab terminal 134 may include a tab proximal section 158 that can be connected to the housing of a battery cell. The tab proximal section 158 may be substantially straight along its length.

The tab terminal 134 may additionally include a first bend 162 that positions a tab end section 160 at an angle relative to the tab proximal section 158. The tab end section 160 may include a proximal tip portion 166 and a distal tip portion 168. A second bend 170 may position the distal tip portion 168 at an angle relative to the proximal tip portion 166. The distal tip portion 168 may extend toward the tab proximal section 158 and may either contact the tab proximal section 158 or be slightly spaced therefrom.

By virtue of the second bend 170, the tab end section 160 may extend along a curved path 174 and therefore exhibits a convex shape. The curved path 174 forms a barrier that provides protection for sensitive components from weld spatter. The tab terminal 134 is thus configured to stop the momentum of weld spatter and/or redirect weld spatter to benign areas of a battery array/traction battery pack 24 during the process of welding the tab end section 160 of the tab terminal 134 to a busbar.

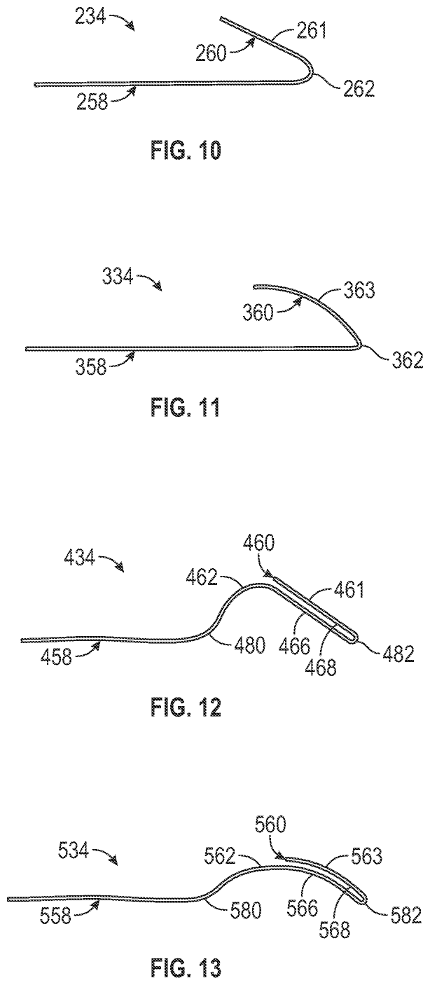

FIG. 10 illustrates another exemplary tab terminal 234 that is shaped to optimize a battery cell-to-busbar electrical connection. The exemplary tab terminal 234 may include a tab proximal section 258 that can be connected to the housing of a battery cell. The tab proximal section 258 may be substantially straight along its length.

The tab terminal 234 may additionally include a first bend 262 that positions a tab end section 260 at an angle relative to the tab proximal section 258 to provide a simple hook shape. The tab end section 260 may be substantially straight to provide a straight interface surface 261.

FIG. 11 illustrates another exemplary tab terminal 334 that is shaped to optimize a battery cell-to-busbar electrical connection. The exemplary tab terminal 334 may include a tab proximal section 358 that can be connected to the housing of a battery cell. The tab proximal section 358 may be substantially straight along its length.

The tab terminal 334 may additionally include a first bend 362 that positions a tab end section 360 at an angle relative to the tab proximal section 358. The tab end section 360 may extend along a curved path to provide curved interface surface 363. The tab terminal 334 therefore provides a curved hook shape.

FIG. 12 illustrates another exemplary tab terminal 434 that is shaped to optimize a battery cell-to-busbar electrical connection. The exemplary tab terminal 434 may include a tab proximal section 458 that can be connected to the housing of a battery cell. The tab proximal section 458 may be substantially straight along its length and may also include a first bend 480.

The tab terminal 434 may additionally include a second bend 462 that positions a tab end section 460 at an angle relative to the tab proximal section 458 to provide an alternative hook shape. The tab end section 460 may include a proximal tip portion 466 and a distal tip portion 468 that is in touching contact with the proximal tip portion 466 by virtue of a third bend 482. The distal tip portion 468 may be substantially straight to provide a straight interface surface 461. The proximal tip portion 466 may also be substantially straight.

FIG. 13 illustrates yet another exemplary tab terminal 534 that is shaped to optimize a battery cell-to-busbar electrical connection. The exemplary tab terminal 534 may include a tab proximal section 558 that can be connected to the housing of a battery cell. The tab proximal section 558 may be substantially straight along its length and may also include a first bend 580.

The tab terminal 534 may additionally include a second bend 562 that positions a tab end section 560 at an angle relative to the tab proximal section 558 to provide another alternative hook shape. The tab end section 560 may include a proximal tip portion 566 and a distal tip portion 568. The distal tip portion 568 may be angled relative to the proximal tip portion 566 via a third bend 582. The distal tip portion 568 may extend along a curved path to provide curved interface surface 563.

The exemplary tab terminals shape variations described above are designed to reduce weld through and weld spatter issues by providing a local thickness increase at the tab ends. The tab terminals can therefore provide for more consistent and accurate tab terminal-to-busbar alignment and can further provide for reduced welding errors, thereby increasing manufacturing efficiencies, reducing the need for weld repairs, and improving overall weld quality.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery cell, comprising:
a housing; and
a tab terminal that protrudes outwardly from the housing,
wherein the tab terminal includes a tab end section having a shape that provides a local thickness increase adapted for reducing weld spatter when welding the tab terminal to a busbar.

2. The battery cell as recited in claim 1, wherein the shape includes a crimped portion that provides the local thickness increase at the tab end section.

3. The battery cell as recited in claim 1, wherein the shape extends along a curved path that provides a barrier for protecting sensitive components from the weld spatter.

4. The battery cell as recited in claim 3, wherein the curved path establishes a convex shape of the tab end section.

5. The battery cell as recited in claim 1, wherein a first bend connects the tab end section to a tab proximal section of the tab terminal.

6. The battery cell as recited in claim 5, wherein a second bend connects a distal tip portion of the tab end section to a proximal tip portion of the tab end section.

7. The battery cell as recited in claim 6, wherein the distal tip portion is folded toward the proximal tip portion about the second bend.

8. The battery cell as recited in claim 7, wherein the second bend establishes at least a portion of a crimped portion of the tab end section.

9. The battery cell as recited in claim 5, wherein a second bend positions a distal tip portion of the tab end section at an angle relative to a proximal tip portion of the tab end section.

10. The battery cell as recited in claim 9, wherein the distal tip portion extends toward the tab proximal section and is spaced therefrom.

11. A traction battery pack, comprising:
a busbar including an opening and a weld joint backing structure provided near the opening;
a battery cell including a tab terminal that extends into the opening to a position adjacent to the weld joint backing structure; and
a weld that secures the tab terminal to the weld joint backing structure.

12. The traction battery pack as recited in claim 11, wherein the weld joint backing structure includes a bent portion.

13. The traction battery pack as recited in claim 12, wherein a distal end section of the tab terminal is received against an angled surface of the bent portion of the weld joint backing structure.

14. The traction battery pack as recited in claim 13, wherein the distal end section of the tab terminal includes a crimped portion or extends along a curved path to establish a local thickness increase.

15. The traction battery pack as recited in claim 11, wherein the weld joint backing structure includes a bent portion that is bent relative to a body of the busbar.

16. The traction battery pack as recited in claim 15, wherein a distal end section of the tab terminal is received against an angled surface of the bent portion.

17. The traction battery pack as recited in claim 16, wherein the distal end section includes a crimped portion or extends along a curved path to establish a local thickness increase.

18. The traction battery pack as recited in claim 11, wherein the tab terminal includes at least two bends.

19. The traction battery pack as recited in claim 11, wherein the busbar is comprised of a first metallic material, and the tab terminal is comprised of a second metallic material that is different from the first metallic material.

20. A method for establishing an electrical connection between a battery cell and a busbar, comprising:
positioning a tab terminal of the battery cell into an opening of the busbar and to a position adjacent to a weld joint backing structure of the busbar; and
welding the tab terminal to the weld joint backing structure,
wherein the tab terminal includes a shape that provides a local thickness increase within a tab end section of the tab terminal for reducing weld spatter during the welding.
